(19) United States
(12) Patent Application Publication
(10) Pub. No.: US 2025/0109000 A1
(43) Pub. Date: Apr. 3, 2025

(54) DEVICE FOR COMPENSATING FOR HEIGHT DIFFERENCES ON A VEHICLE

(71) Applicant: EMUK GmbH & Co. KG, Lahr (DE)

(72) Inventor: Georg VETTER, Friesenheim (DE)

(73) Assignee: EMUK GmbH & Co. KG, Lahr (DE)

(21) Appl. No.: 18/834,715

(22) PCT Filed: Jan. 9, 2023
(86) PCT No.: PCT/EP2023/050335

§ 371 Date: Jul. 31, 2024

(30) Foreign Application Priority Data
Feb. 4, 2022 (DE) 10 2022 102 687.6

(51) Int. Cl. B66F 3/35

(52) U.S. Cl. CPC B66F 3/35

(57) ABSTRACT

A device (1) for compensating for height differences on a parked vehicle (2). In order to seal a hose opening (5) of a hose section (4), which forms a lifting bag (3) of the device (1), it is provided, among other things, to arrange a seal (8) between two clamping strips (6, 7) holding the hose opening (5) together.

### CROSS-REFERENCE TO RELATED APPLICATIONS

This application is a 371 National Phase of PCT International Application No. PCT/EP2023/050335, filed Jan. 9, 2023, which claims priority from German Patent Application No. 10 2022 102 687.6, filed Feb. 4, 2022, both of which are incorporated herein by reference as if fully set forth.

### TECHNICAL FIELD

The invention relates to a device for compensating height differences on a vehicle, wherein the device has a lifting bag which can be filled with a fluid, preferably with air or water, wherein the lifting bag is formed from at least one hose section, wherein the hose section has at least one hose opening which is closed by clamping strips of the device.

### BACKGROUND

To compensate for height differences on a vehicle, the lifting bag can be placed under one or more wheels of the vehicle standing on an uneven and/or at least partially inclined surface at or near a point and filled with a fluid, preferably air or water.

Such a device is already known from the publication DE 10 2012 014 661 A1 and has proven its worth.

### SUMMARY

The object of the invention is to provide a device of the aforementioned type which can be easily manufactured.

In order to solve the object, it is initially proposed in the aforementioned device that a seal is arranged, in particular clamped, between the two clamping strips in order to seal a clamping point defined by the clamping strips on the hose section.

In this way, there is no need for comparatively complex gluing of the hose opening.

The at least one hose opening of the lifting bag formed from at least one hose section can be reliably sealed using the seal even without adhesive.

In one embodiment of the device, a hose section with two hose openings can be used. The hose openings can be arranged at opposite ends of the hose section. Each of the hose openings can be closed by two clamping strips. The device then has two pairs of clamping strips for closing the hose openings of the hose section. To seal each of the two hose openings, a seal can then be arranged between the clamping strips on both hose openings.

A sealing strip section can be used as a seal. The seal can be made of rubber, plastic and/or synthetic rubber, for example.

A particularly good sealing effect is achieved if the seal is arranged inside the at least one hose section and between the clamping strips. In this way, it is possible to transfer the pressure transmitted by the clamping strips to the material of the hose section to close the hose opening to the seal without having to contact the seal directly with the clamping strips. This can protect the seal from damage.

In one embodiment, the seal has at least one thickening, preferably on the edge. The thickening can be deformed or crimped by means of the clamping strips in such a way that a satisfactory sealing effect can also be achieved in an edge or corner area of the hose opening to be sealed. In one embodiment of the device, the at least one thickening can have a round or circular cross-section.

Preferably, the seal has at least two thickenings, preferably on the edge, for example oriented parallel to each other and/or to the longitudinal direction of the seal. The thickenings can be oriented in the longitudinal direction of the clamping strips when the seal is in the position of use.

In one embodiment of the seal, the at least one edge-side thickening protrudes on opposite flat sides of the seal. In this way, the seal can be deformed on both flat sides of the seal to promote the sealing effect.

The at least one edge-side thickening of the seal can extend over at least a large part of the length of the seal, in particular the sealing strip section. The seal can have a dimension that corresponds to at least 80% of a length of the two clamping strips.

In one embodiment of the device, it is provided that the seal, in particular between two edge-side thickenings, has at least one through-opening for a fastening means, in particular for a screw, for connecting the clamping strips. The two clamping strips can also each have at least one such through-opening. The at least one through-opening can be surrounded by at least one, for example annular, preferably closed annular, thickening. The thickening can surround the through-opening in a closed manner and thus seal it reliably. The thickening can have a round or circular cross-section, for example. The thickening can be squeezed by the clamping strips of the device and improve the sealing effect of the seal, particularly in the area of the fastening means.

In this way, it is possible to connect the two clamping strips in their clamping position on the lifting bag to close the hose opening of the hose section with the aid of a fastening means and to guide this through both the clamping strips and the seal arranged between the clamping strips. Preferably, a screw is used as the fastening means, as previously mentioned.

In a preferred embodiment of the device, it is provided that the clamping strips and/or the seal arranged between the clamping strips have at least two, preferably in each case one row of such through-openings. In this way, it is possible to achieve a uniform surface pressure of the hose section arranged between the clamping strips and/or the seal arranged between the clamping strips with the aid of the fastening means, in particular with the aid of the screws. This can promote the sealing effect of the seal accordingly.

To solve the object, a device of the type mentioned at the beginning is also proposed with one or more of the means and features disclosed herein directed to such a device. To solve the object, it is further proposed in the device referred to at the beginning that at least one of the clamping strips has a clamping profile on its clamping side facing the hose section. Preferably, both clamping strips have clamping profiles on their respective clamping sides facing the hose section. The clamping profiles can be mutually corresponding clamping profiles.

With the aid of the clamping profile on the at least one clamping strip of the two clamping strips of the device associated with a hose opening, it is possible to increase the pressure transmitted to the hose section with the aid of the clamping strips in the area of the clamping profile in such a way that the hose opening of the hose section is sealed in a fluid-tight manner. The previously mentioned gluing of the hose opening of the hose section can also be dispensed with in this case. This promotes the simplest and cleanest possible adhesive-free production of the device.

In one embodiment of this device, a hose section with two hose openings can be used. The hose openings can be arranged at opposite ends of the hose section. Each of the hose openings can be closed in each case by two clamping strips. The device then has two pairs of clamping strips for closing the hose openings of the hose section. To seal each of the two hose openings, at least one clamping strip of the clamping strips assigned to the hose openings in pairs can then have a clamping profile.

In a preferred variant of the invention, the device has the aforementioned clamping profile on at least one of the clamping strips and the aforementioned seal between the two clamping strips.

This ensures a particularly reliable seal of the hose opening of the hose section forming the lifting bag. The clamping profile on the at least one clamping strip of the device can increase the pressure caused by the clamping strips in such a way that a particularly reliable seal is created.

In one embodiment of the device, it is provided that at least one clamping strip has a clamping profile with at least one clamping structure. The clamping structure may, for example, be a clamping web and/or a clamping groove. The clamping web can be a projection on the clamping side of the clamping strip.

In particular, if the clamping structure is a continuous, uninterrupted clamping web, the clamping web can cause an increase in the clamping force transmitted from the clamping web to the hose section and/or the seal along a line. This can promote a particularly reliable seal of the hose opening.

The at least one clamping structure can be oriented in the longitudinal direction of the clamping strip and/or extend over at least a large part of the length of the clamping strip.

A clamping strip can have a clamping profile with at least one clamping groove as a clamping structure. The clamping groove can be a clamping groove corresponding to at least one clamping web of the other clamping strip. The clamping groove of one clamping strip and the clamping web of the other clamping strip can have corresponding geometries, so that a hose material and/or material of the seal displaced by the at least one clamping web when the clamping strips are attached can be displaced into the corresponding clamping groove of the other clamping strip.

The at least one clamping groove can be oriented in the longitudinal direction of the clamping strip and/or extend over at least a major part of the length of the clamping strip.

In one embodiment of the device, at least one of the two clamping strips has an L-shaped cross-section. This clamping strip can have two legs of different lengths in cross-section. The clamping profile can be formed with the at least one clamping structure, in particular with the at least one clamping web, on the longer leg of the two legs.

The two clamping strips can be screwed together. It is also possible that the two clamping strips each have at least one through-opening for a fastening means, in particular for a screw. In one embodiment of the device, it is provided that at least one through-opening is arranged between two clamping webs of a clamping strip. Furthermore, it is possible that at least one through-opening is arranged between two clamping grooves in a clamping strip.

In one embodiment of the device with a clamping strip, which has two preferably parallel clamping webs, and a further clamping strip, which has two preferably parallel clamping grooves, a row of through-openings can be arranged between the clamping webs and a further row of through-openings can be arranged between the clamping grooves. In this way, the two clamping strips can be connected to each other, for example by means of screws in an area between the clamping structures of the clamping profiles of the clamping strips.

For filling and/or emptying the lifting bag, the device, in particular the lifting bag, can have at least one valve. The at least one valve can preferably be arranged at the edge of the hose section of the lifting bag and/or adjacent to the clamping strips associated with a hose opening. By arranging the valve at the edge of the hose section of the lifting bag, the lifting bag can be driven over by a vehicle without driving over the valve and damaging it in the process.

The aforementioned lifting bag can be positioned under a wheel standing on uneven ground to compensate for height differences on a parked vehicle, such as a caravan or motorhome. By filling the lifting bag of the device, the volume of the lifting bag can be increased and the vehicle lifted accordingly in order to achieve the desired height compensation on the vehicle and move the vehicle to a horizontal position.

### BRIEF DESCRIPTION OF THE DRAWINGS

The invention is described in more detail below with reference to an exemplary embodiment, but is not limited to this exemplary embodiment. Further exemplary embodiments result from combining the features of individual or several claims with one another and/or in combination of individual or several features of the exemplary embodiment, wherein:

FIG. 1: shows a rear view of a caravan or motorhome, the right rear wheel of which, as seen by the observer, is supported by the device according to the invention in such a way that the vehicle floor is leveled with respect to the uneven ground,

FIG. 2: shows a top view of the device shown in FIG. 1 in the position of use,

FIGS. 3 to 5: show different views of one of two clamping strips, with which a hose opening of a hose section forming a lifting bag of the device can be closed, wherein the clamping strip has a clamping profile with two parallel clamping webs extending in the longitudinal direction of the clamping strip over the entire length of the clamping strip,

FIGS. 6 to 8: show different views of another of two clamping strips, with which a hose opening of a hose section forming a lifting bag of the device can be closed, wherein the clamping strip has a clamping profile with two parallel clamping grooves extending in the longitudinal direction of the clamping strip over the entire length of the clamping strip,

FIG. 9: shows a top view of a seal arranged between the clamping strips of the device in the position of use,

FIG. 10: shows a side view of the seal shown in FIG. 9,

FIG. 11: an end view of the seal shown in FIGS. 9 and 10 and

FIG. 12: shows a perspective view of the seal shown in FIGS. 9 to 11.

### DETAILED DESCRIPTION

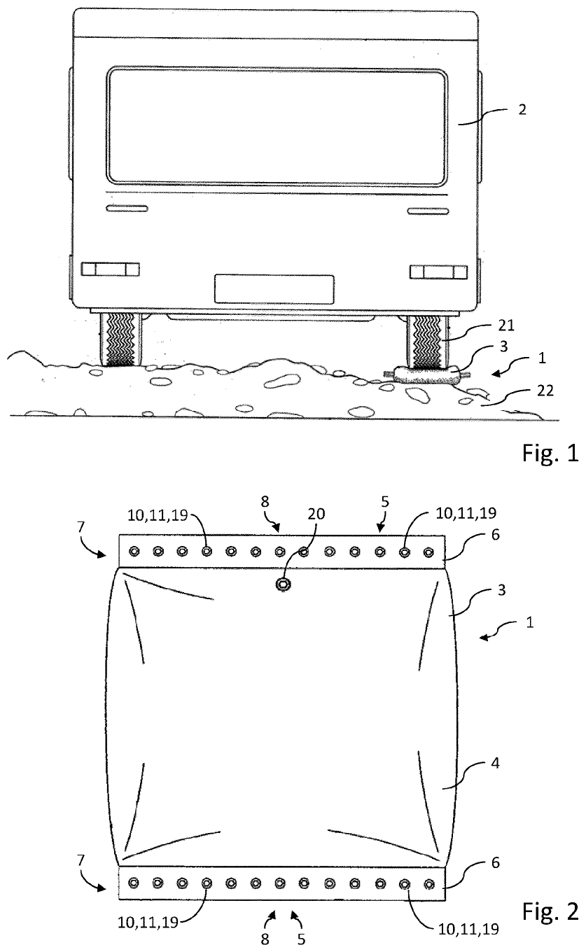

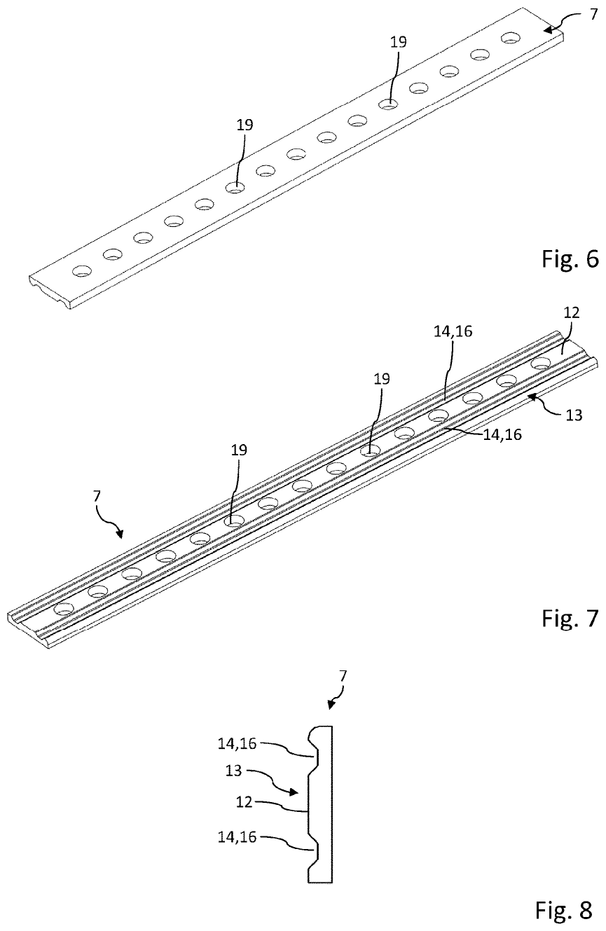

FIGS. 1-8 and 9 to 12 show at least parts of a device for compensating height differences on a vehicle 2, designated as a whole by reference sign 1.

The device 1 comprises a lifting bag 3 which can be filled with a fluid, preferably air or water. The lifting bag 3 is formed from a hose section 4. The hose section 4 has at least one, in the present exemplary embodiment two, hose openings 5. The hose openings 5 are formed at opposite ends of the hose section 4 and are each closed by a pair of clamping strips 6 and 7 of the device 1. The device 1 thus has a total of four clamping strips 6 and 7.

A seal 8 is arranged between two clamping strips 6 and 7 assigned to a hose opening 5, namely clamped in, in order to seal a clamping point on the hose section 4 defined by the clamping strips 6, 7.

The seal 8 consists of a sealing strip section and is arranged between the two clamping strips 6 and 7 and within the hose section 4 to close the respective hose opening 5.

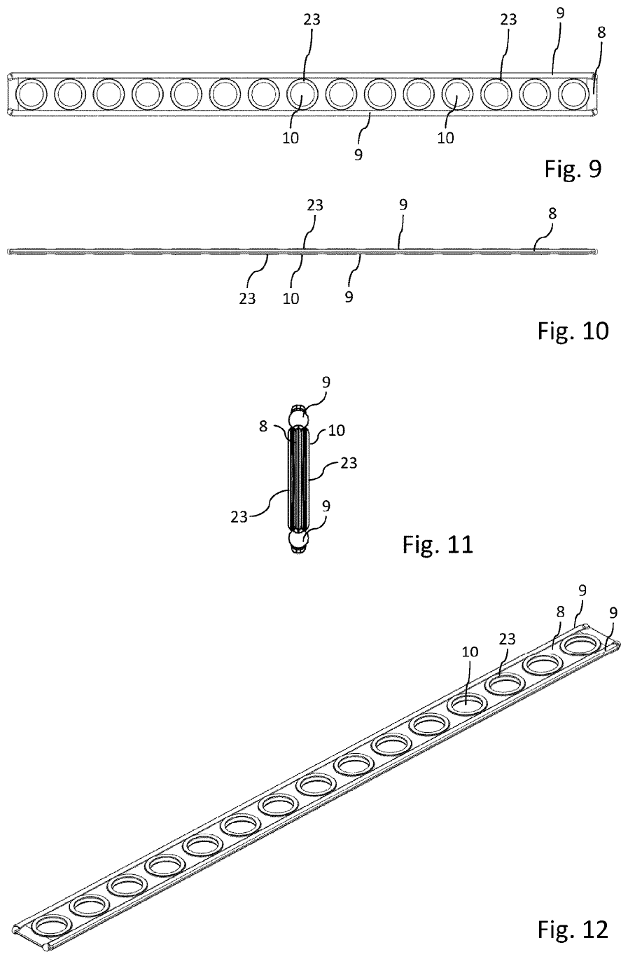

According to FIGS. 9 to 12, the seal 8 has two edge-side thickenings 9, which protrude from the top and bottom of the seal 8, are oriented in the longitudinal direction of the clamping strips 6 and 7 when the seal 8 is in the position of use and extend over the entire length of the seal 8. Between its edge-side thickenings 9, the seal 8 has a series of through-openings 10 for fastening means 11, namely for screws, which are used to connect the clamping strips 6 and 7. Each of the through-openings 10 is surrounded on the top and bottom of the seal 8 by a closed annular thickening 23. The annular thickenings 23 surround the through-openings 10 of the seal 8 in a closed manner and, just like the edge-side thickenings 9, can be crimped using the clamping strips 6 and 7 for sealing and promote the sealing effect of the seal 8.

According to FIG. 11, the thickenings 9 and 23 of the seal 8 have a round, in particular circular, cross-section.

The two clamping strips 6 and 7 each have a clamping profile 13 on their clamping sides 12 facing the hose section 4. The two clamping profiles 13 of the clamping strips 6 and 7 are corresponding clamping profiles.

The clamping profiles 13 of the clamping strips 6 and 7 comprise clamping structures 14, namely, in the case of the clamping strip 6, two parallel, spaced-apart clamping webs 15 extending in the longitudinal direction of the clamping strip 6. On the clamping strip 7, two parallel, spaced-apart clamping grooves 16 extending in the longitudinal direction of the clamping strip 7 are provided as clamping structures 14. The clamping structures 14, i.e. the clamping webs 15 and the clamping grooves 16, each extend over the entire length of the respective clamping strip 6 or 7. The clamping structures 14, 15, 16 can act on the seal 8 and in particular on the aforementioned thickenings 9 of the seal 8 and squeeze them to improve the sealing effect.

A comparison of FIGS. 5 and 8, which show the clamping strips 6 and 7 in a side view, makes it clear that the clamping webs 15 and the clamping grooves 16 of the clamping profiles 13 of the two clamping strips 6 and 7 have corresponding geometries.

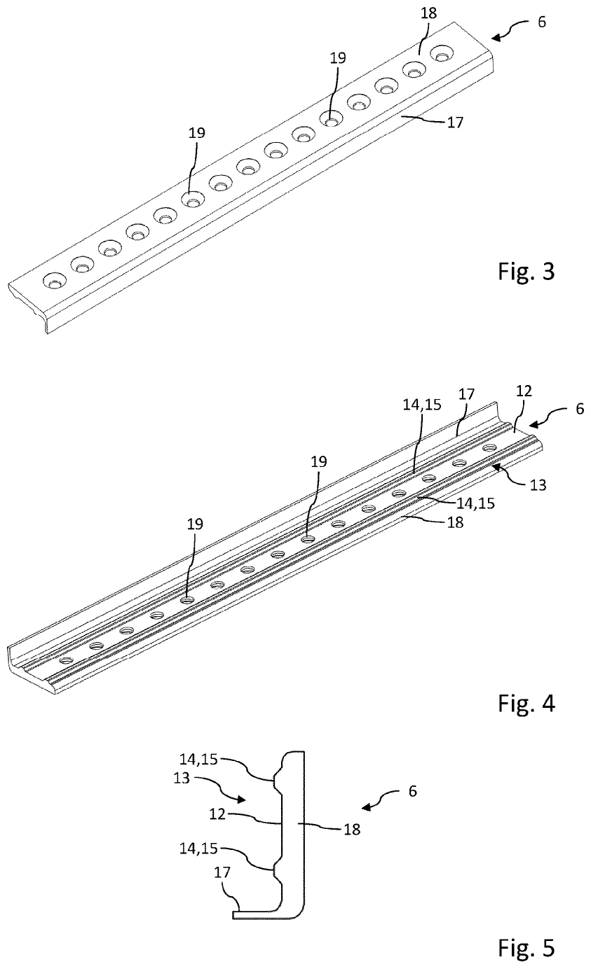

FIGS. 3 to 5, which show different views of the clamping strip 6, illustrate that the clamping strip 6 has an L-shaped cross-section. The clamping strip 6 comprises two legs 17 and 18 of different lengths in cross-section, wherein the clamping profile 13 is formed with the two clamping webs 15 oriented parallel to each other on the longer leg 18 of the two legs 17 and 18.

In the position of use of the device 1, the two clamping strips 6 and 7, each assigned to a hose opening 5, are screwed together. For this purpose, both clamping strips 6 and 7, as well as the previously explained seal 8, each have a series of through-openings 19 for the fastening means 11, namely for screws.

FIGS. 3-5 and 6-8 illustrate that the through-openings 19 are arranged between the clamping structures 14, namely on the one hand between the clamping webs 15 of the clamping strip 6 and on the other hand between the clamping grooves 16 of the clamping strip 7.

In order to fill the lifting bag 3 with a fluid, preferably air or water, the device 1 has a valve 20 through which the lifting bag 3 can be filled with the fluid. The valve 20 is arranged at the edge of the hose section 4 of the lifting bag 3 and adjacent to one of the two pairs of clamping strips 6 and 7. Due to the arrangement of the valve 20 at the edge of the hose section 4 of the lifting bag 3, the lifting bag 3 can be driven over with a vehicle 2 without driving over the valve 20 and damaging it in the process.

FIG. 1 shows the device 1 with its lifting bag 3 in the operating position under a wheel 21 of a vehicle 2.

It is easy to see that the fluid-filled lifting cushion 3 of the device 1 compensates for unevenness of a surface 22 on which the vehicle 3 is parked in such a way that the vehicle 3 is horizontal or at least almost horizontal.

The invention relates to a device 1 for compensating for height differences on a parked vehicle 2. In order to seal a hose opening 5 of a hose section 4, which forms a lifting bag 3 of the device 1, it is proposed, among other things, to arrange a seal 8 between two clamping strips 6 and 7 holding the hose opening 5 together.

### LIST OF REFERENCE SIGNS

1 Device
2 Vehicle
3 Lifting bags
4 Hose section
5 Hose opening
6 Clamping strip
7 Clamping strip
8 Seal
9 Edge-side thickening
10 Through-opening
11 Fastening means
12 Clamping side
13 Clamping profile
14 Clamping structure
15 Clamping web
16 Clamping groove
17 Legs from 6
18 Longer leg of 6
19 Through-opening on 6 and 7
20 Valve
21 Wheel
22 Surface
23 Ring-shaped thickening

1. A device (1) for compensating for height differences on a vehicle (2), the device (1) comprising:
a lifting bag (3) which is fillable with a fluid, wherein the lifting bag (3) is formed from at least one hose section (4), and the hose section (4) has at least one hose opening (5) which is closed by clamping strips (6, 7); and
a seal (8) arranged between the two clamping strips (6, 7) in order to seal a clamping point defined by the clamping strips (6, 7) on the hose section (4).

2. The device (1) according to claim 1, wherein the seal (8) is a sealing strip section.

3. The device (1) according to claim 1, wherein the seal (8) has at least one thickening (9) which is oriented in a longitudinal direction of the clamping strips (6, 7) when the seal (8) is in a position of use and/or extends over at least a part of a length of the seal (8).

4. The device (1) according to claim 1, wherein the seal (8) has at least one through-opening (10) for a fastener (11) for connecting the clamping strips (6, 7).

5. The device (1) according to claim 4, wherein at least one of the clamping strips (6, 7) has a clamping profile (13) on a clamping side (12) thereof facing the hose section (4).

6. The device (1) according to claim 5, wherein at least one of the clamping strips (6, 7) has the clamping profile (13) that includes at least one clamping structure (14).

7. The device (1) according to claim 6, wherein the at least one clamping structure (14) at least one of a) is oriented in a longitudinal direction of the clamping strip (6, 7) or b) extends over at least a major part of a length of the clamping strip (6, 7).

8. The device (1) according to claim 1, wherein one clamping strip (6, 7) has a clamping profile (13) with at least one clamping groove (16).

9. The device (1) according to claim 5, wherein at least one of the clamping strips (6, 7) of the two clamping strips (6, 7) has an L-shaped cross-section, and the clamping profile (13) is formed with at least one clamping web (15) and/or with at least one clamping groove (16) on a longer leg (18) of the two legs (17, 18).

10. The device (1) according to claim 1, wherein the clamping strips (6, 7) are at least one of screwed together or each have at least one through-opening (19) for a fastener (11), wherein at least one through-opening (10) is arranged between at least one of two clamping webs (15) of one of the clamping strips (6, 7) or two clamping grooves (16) of one of the clamping strips (6, 7).

11. The device (1) according to claim 1, further comprising h at least one valve (20) for at least one of filling or emptying the lifting bag (3), and the valve is arranged at least one of adjacent to the clamping strips (6, 7) or at an edge of the hose section (4).

12. The device (1) according to claim 1, wherein the seal (8) is arranged inside the at least one hose section (4).

13. The device (1) according to claim 1, wherein the at least one thickening comprises at least two edge-side thickenings (9).

14. The device (1) according to claim 4, wherein the at least one through-opening (10) is surrounded by at least one thickening (23) of the seal (8).

15. The device (1) according to claim 8, wherein the at least one clamping groove (16) corresponds to at least one clamping web (15) of the other clamping strip (6, 7).
